(19) United States
(12) Patent Application Publication
(10) Pub. No.: US 2022/0076103 A1
(43) Pub. Date: Mar. 10, 2022

(54) Data Processing Processor, Corresponding Method and Computer Program.

(71) Applicants: UNIVERSITE DE BOURGOGNE, DlJON (FR); UNIVERSITE DE TECHNOLOGIE DE TROYES, TROYES (FR)

(72) Inventors: Michel Doussot, TROYES (FR); Michel Paindavoine, PLOMBIERES-LES-DIJON (FR)

(21) Appl. No.: 17/414,628

(22) PCT Filed: Dec. 5, 2019
(86) PCT No.: PCT/EP2019/083891

§ 371 Date: Jun. 16, 2021

(30) Foreign Application Priority Data
Dec. 18, 2018 (FR) 1873141

(51) Int. Cl. G06N 3/04; G06N 3/063

(52) U.S. Cl. CPC G06N 3/0481; G06N 3/063

(57) ABSTRACT

A data processing processor includes at least one processing memory and a computation unit. The computation unit includes a set of configurable computation units called configurable neurons, each configurable neuron of the set of configurable neurons includes a module configured to compute combination functions and a module configured to compute activation functions. Each module for computing activation functions includes a register for receiving a configuration command so that the command determines an activation function to be executed from at least two activation functions that can be executed by the module for computing activation functions.

### 1. TECHNICAL FIELD

The invention relates to the materialisation of neural networks. More particularly, the invention relates to the physical implementation of adaptable and configurable neural networks. Still more specifically, the invention relates to the implementation of a generic neural network whose configuration and operation can be adapted according to the needs.

### 2. PRIOR ART

In the field of computerised data processing, a neural network is a digital system whose design is originally inspired by the functioning of biological neurons. A neural network is more generally modelled as a system comprising processing algorithms and statistical data (including weights). The processing algorithm allows for the processing of input data, which is combined with the statistical data to obtain output results. The processing algorithmic consists of defining the calculations that are performed on the input data in combination with the statistical data of the network to provide output results. At the same time, computerised neural networks are divided into layers. They generally have an input layer, one or more intermediate layers and an output layer. The general operation of the computerised neural network, and thus the general processing applied to the input data, consists in implementing an iterative algorithmic process of processing, in which the input data is processed by the input layer, which produces output data, this output data becoming input data of the next layer and so on, as many times as there are layers, until the final output data, which is delivered by the output layer, is obtained.

Since the original purpose of the artificial neural network was to mimic the operation of a biological neural network, the algorithm used to combine the input and statistical data from one layer of the network includes processing that attempts to mimic the operation of a biological neuron. In an artificial neural network (simply called neural network in the following), it is considered that a neuron generally includes a combination function and an activation function. This combination function and this activation function are implemented in a computerised manner by using an algorithm associated with the neuron or with a set of neurons located in a same layer.

The combination function is used to combine the input data with the statistical data (the synaptic weights). The input data is materialised in the form of a vector, each point of the vector representing a given value. The statistical values (i.e. synaptic weights) are also represented by a vector. The combination function is therefore formalised as a vector-to-scalar function, thus:
in MLP type (multilayer perceptron) neural networks, a linear combination of the inputs is computed, that is, the combination function returns the scalar product between the vector of the inputs and the vector of the synaptic weights;
in RBF type (radial basis function) neural networks, the distance between the inputs is computed, that is, the combination function returns the Euclidean norm of the vector resulting from the vector difference between the input vector and the vector corresponding to the synaptic weights;

The activation function, for its part, is used to break linearity in the functioning of the neuron. The thresholding functions generally have three intervals:
below the threshold, the neuron is non-active (often in this case, its output is 0 or −1);
around the threshold, a transition phase;
above the threshold, the neuron is active (often in this case, its output is 1).

Classic activation functions include, for example:
The sigmoid function;
The hyperbolic tangent function;
The Heaviside function.

There are countless publications on neural networks. Generally speaking, these publications deal with theoretical aspects of neural networks (such as the search for new activation functions, or the management of layers, or feedback, or learning, or more precisely gradient descent in machine learning). Other publications deal with the practical use of systems implementing computerised neural networks to address specific problems. Less frequently, we also find publications related to the implementation, on a specific component, of particular neural networks. This is, for example, the case of the publication “FPGA Implementation of Convolutional Neural Networks with Fixed-Point Calculations” by Roman A. Solovye et al (2018), in which it is proposed to localise the calculations performed within a neural network on a hardware component. The hardware implementation proposed in this document is however limited in scope. Indeed, it is limited to the implementation of a convolutional neural network in which many reductions are performed. However, it does provide an implementation of fixed point or floating point calculations. The paper “Implementation of Fixed-point Neuron Models with Threshold, Ramp and Sigmoid Activation Functions” by Lei Zhang (2017) also discusses the implementation of a neural network including the implementation of fixed-point calculations for a particular neuron and three particular activation functions, implemented singly.

However, the solutions described in these articles do not solve the hardware implementation problems of generic neural networks, that is, neural networks implementing general neurons, which can implement a multiplicity of neural network types, including mixed neural networks comprising several activation functions and/or several combination functions.

Therefore, there is a need to provide a device that allows the implementation of a neural network, implementing neurons in a reliable and efficient manner, that is furthermore reconfigurable and that can fit on a reduced processor area.

### 3. SUMMARY OF THE INVENTION

The invention does not pose at least one of the problems of the prior art. More particularly, the invention relates to a data processing processor, said processor comprising at least one processing memory and one computation unit, said processor being characterised in that the computation unit comprises a set of configurable computation units called configurable neurons, each configurable neuron of the set of configurable neurons comprising a module for computing combination functions and a module for computing activation functions, each module for computing activation functions comprising a register for receiving a configuration command, so that said command determines an activation function to be executed from at least two activation functions that can be executed by the module for computing activation functions.

Thus, the invention makes it possible to configure, upon execution, a set of reconfigurable neurons, so that they execute a predetermined function according to the control word provided to the neurons during the execution. The control word, received in a memory space, which may be dedicated, of the reconfigurable neuron, may be different for each layer of a particular neural network, and thus form part of the parameters of the neural network to be executed (implemented) on the processor in question.

According to a particular embodiment, characterised in that the at least two activation functions executable by the module for computing activation functions belong to the group comprising:
the sigmoid function;
the hyperbolic tangent function;
the Gaussian function;
the RELU (“Rectified linear Unit”) function.

Thus, a reconfigurable neuron is able to implement the main activation functions used for the industry.

According to a particular embodiment, the module for computing activation functions is configured to perform an approximation of said at least two activation functions.

Thus, the computational capacity of the neural processor embedding a set of reconfigurable neurons can be reduced leading to a reduction in the size, power consumption and thus energy required to implement the proposed technique compared to existing techniques.

According to a particular feature, the module for computing activation functions comprises a sub-module for computing a basic operation corresponding to an approximation of the calculation of the sigmoid of the absolute value of λx:

$$f ( x ) = \frac{1}{1 + {e}^{\vert λ x \vert}} . \qquad [ Math 1 ]$$

Thus, using a basic operation, it is possible to approximate, by a series of simple calculations, the result of a particular activation function, defined by a control word.

According to a particular embodiment, the approximation of said at least two activation functions is performed as a function of an approximation parameter λ.

The approximation parameter λ can thus be used, in conjunction with the control word, to define the behaviour of the computation unit of the basic operation to compute a detailed approximation of the control word activation function. In other words, the control word routes the computation (performs a routing of the computation) to be performed in the activation function computation unit while the approximation parameter λ conditions (configures) this computation.

According to a particular feature, the approximation of said at least two activation functions is performed by configuring the module for computing activation functions so that the computations are performed in fixed point or floating point modes.

When performed in fixed point mode, this advantageously further reduces the resources required for the implementation of the proposed technique, and thus further reduces the energy consumption. Such an implementation is advantageous for low capacity/low consumption devices such as connected objects.

In a particular feature, the number of bits associated with fixed-point or floating-point calculations is set for each layer of the network. Thus, an additional parameter can be stored in the sets of layer parameters of the neural network.

According to a particular embodiment, the data processing processor comprises a network configuration storage memory within which neural network execution parameters (PS, cmd, λ) are stored.

According to another implementation, the invention also relates to a method for processing data, said method being implemented by a data processing processor comprising at least one processing memory and a computation unit, the computation unit comprises a set of configurable computation units called configurable neurons, each configurable neuron of the set of configurable neurons comprising a module for computing combination functions and a module for computing activation functions, the method comprising:
an initialisation step comprising the loading in the processing memory of a set of application data and the loading of a set of data, corresponding to the set of synaptic weights and layer configurations in the network configuration storage memory;
the execution of the neural network, according to an iterative implementation, comprising for each layer, the application of a configuration command, so that said command determines an activation function to be executed from at least two activation functions executable by the module for computing activation functions, the execution delivering processed data;
the transmission of processed data to a calling application.

The advantages of such a method are similar to those previously stated. However, the method can be implemented on any processor type.

According to a particular embodiment, the execution of the neural network comprises at least one iteration of the following steps, for a current layer of the neural network:
transmission of at least one control word, defining the combination function and/or the activation function implemented for the current layer;
loading of the synaptic weights of the current layer;
loading input data from the temporary storage memory;
computing the combination function, for each neuron and each input vector, as a function of said at least one control word, delivering, for each neuron used, an intermediate scalar;
computing the activation function as a function of the intermediate scalar, and said at least one second control word, delivering, for each neuron used, an activation result;
recording the activation result in the temporary storage memory.

Thus, the invention makes it possible, within a dedicated processor (or within a specific processing method), to optimise the computations of non-linear functions by factoring calculations and approximations which make it possible to reduce the computational load of the operations, particularly at the level of the activation function.

It is understood, within the scope of the description of the present technique according to the invention, that a step for transmitting information and/or a message from a first device to a second device corresponds at least partially, for this second device, to a step for receiving the transmitted information and/or message, whether this reception and this transmission is direct or whether it is done through other transport, gateway or intermediation devices, including the devices described in the present text according to the invention.

According to a general implementation, the various steps of the methods according to the invention are implemented by one or more software programs or computer programs, comprising software instructions intended to be executed by a data processor of an execution device according to the invention and being designed to control the execution of the various steps of the methods, implemented at the level of the communication terminal, of the electronic execution device and/or of the remote server, within the framework of a distribution of the processes to be carried out and determined by a scripted source code.

Accordingly, the invention also relates to programs, capable of being executed by a computer or by a data processor, these programs comprising instructions for controlling the execution of the steps of the methods as mentioned above.

A program can use any programming language, and can be in the form of source code, object code, or intermediate code between source code and object code, such as in a partially compiled form, or in any other desirable form.

The invention also relates to a data medium readable by a data processor, and comprising instructions of a program as mentioned above.

The data medium may be any entity or device capable of storing the program. For example, the medium can comprise a storage means, such as a ROM, for example a CD-ROM or a microelectronic circuit ROM, or a magnetic recording means, for example a mobile medium (memory card) or a hard disk or SSD.

On the other hand, the data medium can be a transmissible medium such as an electrical or optical signal, that can be carried via an electrical or optical cable, by radio or by other means. The program according to the invention can be downloaded in particular on an Internet-type network.

Alternatively, the data medium can be an integrated circuit in which the program is embedded, the circuit being adapted to execute or to be used in the execution of the above-mentioned method.

According to one embodiment, the invention is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.).

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules. The various embodiments mentioned above can be combined with each other for the implementation of the invention.

### 4. PRESENTATION OF THE DRAWINGS

Other characteristics and advantages of the invention will emerge more clearly upon reading the following description of a preferred embodiment, provided as a simple illustrative non-restrictive example, and the annexed drawings, wherein:

FIG. 1 describes a processor in which the invention is implemented;

FIG. 2 illustrates the splitting of the activation function of a configurable neuron according to the invention;

FIG. 3 describes the sequence of blocks in a particular embodiment, for calculating an approximate value of the activation function;

FIG. 4 describes an embodiment of a method for processing data within a neural network according to the invention.

### 5. DETAILED DESCRIPTION

### 5.1. Statement of the Technical Principle

5.1.1. General

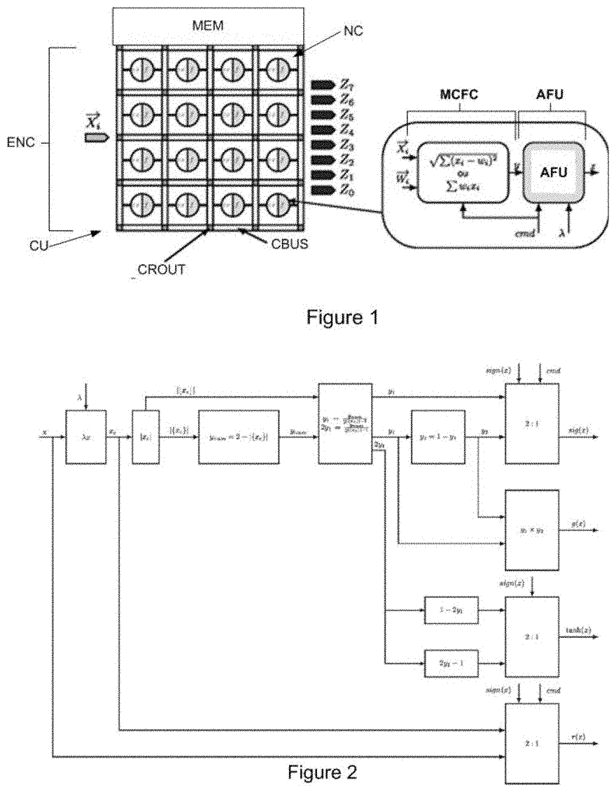

Confronted with the problem of implementing an adaptable and configurable neural network, the inventors focused on the materialisation of the computations to be implemented in different configurations. As explained above, it emerges that neural networks differ from each other mainly by the computations performed. In particular, the layers that make up a neural network implement single neurons that perform both combination functions and activation functions that may be different from one network to another. Now, on a given electronic device, such as a smartphone, tablet, or personal computer, many different neural networks may be implemented, each of which is used by different applications or processes. Therefore, in order to implement such neural networks efficiently, it is not possible to have a dedicated hardware component for each type of neural network to be implemented. It is for this reason that most neural networks today are implemented purely in software and not in hardware (i.e. using direct processor instructions). Based on this observation, as explained above, the inventors have developed a specific neuron that can be reconfigurable materially. Using a control word, such a neuron can take the appropriate form in a neural network being executed. More particularly, in at least one embodiment, the invention is embodied as a generic processor. The computations performed by this generic processor can, depending on the implementation modes, be performed in fixed point or floating point mode. When they are performed in fixed-point mode, the calculations can advantageously be implemented on platforms with few computing and processing resources, such as small devices like connected objects. The processor works with offline learning. It comprises a memory including in particular: the synaptic weights of the various layers; the choice of the activation function of each layer; as well as the configuration and execution parameters of the neurons of each layer. The number of neurons and hidden layers depends on the operational implementation and on economic and practical considerations. In particular, the processor memory is sized according to the maximum capacity of the neural network which is desired to be offered. A structure for storing the results of a layer, also present in the processor, allows the same neurons to be reused for several consecutive hidden layers. For the sake of simplicity, this storage structure is referred to as temporary storage memory. Thus, the number of reconfigurable neurons of the component (processor) is also selected according to the maximum number of neurons which is desired to be allowed for a given layer of the neural network. [FIG. 1] Figure 1 succinctly shows the general principle of the invention. A processor comprises a plurality of configurable neurons (sixteen neurons are shown in the figure). Each neuron is composed of two distinct units: a combination function unit and an activation function unit (AFU). Each of these two units is configurable by a command word (cmd). Neurons are addressed by connection buses (CBUS) and connection routings (CROUT). The input data is represented as a vector (\vec{Xₗ}) that contains a number of input values (eight values in the example). The values are routed through the network to produce eight result scalars (z₀, . . . , z₇). The synaptic weights, the commands and the fitting parameter λ are described next. Thus, the invention relates to a data processing processor, said processor comprising at least one processing memory (MEM) and one computation unit, said processor being characterised in that the computation unit CU) comprises a set of configurable computation units called configurable neurons, each configurable neuron (CN) of the set of configurable neurons (SCN) comprising a module for computing combination functions (MCCF) and a module for computing activation functions (MCAF), each module for computing activation functions (AFU) comprising a register for receiving a configuration command, so that said command determines an activation function to be executed from at least two activation functions that can be executed by the module for computing activation functions (AFU). The processor also comprises a network configuration storage memory (MEMR) within which neural network execution parameters (PS, cmd, λ) are stored. This memory can be the same as the processing memory (MEM)

Various characteristics of the processor which is the object of the invention are described below, and more particularly the structure and functions of a reconfigurable neuron.

5.1.2. Configurable Neuron

A configurable neuron of the network of configurable neurons which is the object of the invention comprises two computation modules (units) which can be configured: one in charge of computing the combination function and one in charge of computing the activation function. However, according to the invention, in order to make the implementation of the network efficient and effective, the inventors have so to speak simplified and factorised (pooled) the computations, so a maximum of common computations can be performed by these modules. In particular, the module for computing activation functions (also called AFU) optimizes the computations common to all activation functions, by simplifying and approximating these computations. An illustrative implementation is detailed below. Figuratively, the module for computing activation functions performs computations to reproduce a result close to that of the chosen activation function, by pooling the computation parts that serve to reproduce an approximation of the activation function.

The artificial neuron, in this embodiment, is broken down into two configurable elements (modules). The first configurable element (module) computes either the scalar product (most networks) or the Euclidean distance. The second element (module) called AFU (for Activation Function Unit) implements the activation functions. The first module implements an approximation of the square root calculation for the computation of the Euclidean distance. Advantageously, this approximation is carried out in fixed point mode, in the case of processors comprising low capacities. The AFU can use the sigmoid, the hyperbolic tangent, the Gaussian, the RELU. As previously explained, the computations which are carried out by the neuron are chosen by the use of a command word named cmd as this is the case of a microprocessor instruction. Thus, this artificial neural circuit is configured by the reception of one or more command words, depending on the mode of implementation. A control word is, in the present case, a signal consisting of a bit or a sequence of bits (e.g. a byte, being able to obtain 256 possible commands or two times 128 commands), which is transmitted to the circuit to configure it. In a general embodiment, the proposed implementation of a neuron enables the realisation of “common” networks as well as the latest generation neural networks such as ConvNet (convolutional neural network). This computing architecture can be implemented, in a practical manner, as a software library for standard processors or as a hardware implementation for FPGAs or ASICs.

Thus, a configurable neuron is composed of a module for computing distance and/or scalar products which depends on the neuron type used, and an AFU module.

A generic configurable neuron, like any neuron, includes fixed or floating point input data of which:
X constitutes the input data vector;
W constitutes the vector of the synaptic weights of the neuron;

and fixed or floating point output data:
z the scalar result of the neuron.

According to the invention, there is also a parameter, λ, which represents the parameter of the sigmoid, the hyperbolic tangent, the Gaussian or the RELU. This parameter is identical for all neurons in a layer. This parameter λ is provided to the neuron with the control word, configuring the implementation of the neuron. This parameter can be called an approximation parameter in the sense that it is used to perform a computation approaching the value of the function from one of the approximation methods presented below.

Specifically, in a general embodiment, the four main functions reproduced (and factorised) by the AFU are the:
sigmoid:

$$sig ( x ) = \frac{1}{1 + {e}^{- λ x}} ; \qquad [ Math 2 ]$$

hyperbolic tangent:

tanh(βx) [Math 3]
the Gaussian function;

$$f ( x ) = exp ( \frac{- {x}^{2}}{2 {σ}^{2}} ) \qquad [ Math 4 ]$$

the RELU (“Rectified linear Unit”) function;

$$max ( 0 , x ) or \{ \begin{matrix}x & x ⩾ 0 \\ ax & x < 0\end{matrix} \}$$

According to the invention, the first three functions are calculated approximately. This means that the configurable neuron does not implement a precise computation of these functions, but instead implements an approximation of the computation of these functions, thus reducing the load, time, and resources required to obtain the result.

The four methods of approximation of these mathematical functions are described below, as well as the architecture of such a configurable neuron.

First Method:

The equation

$$f ( x ) = \frac{1}{1 + {e}^{- x}} , \qquad [ Math 5 ]$$

used to compute the sigmoid, is approximated by the following formula (Allipi):

$$\begin{matrix}f ( x ) = \frac{x + \vert x \vert + 2}{{2}^{\vert ( x ) \vert + 2}} for x \leq 0 & [ Math 6 ] \\ f ( x ) = 1 - \frac{- x + \vert x \vert + 2}{{2}^{\vert ( x ) \vert + 2}} for x > 0 & [ Math 7 ]\end{matrix}$$

where (x) is the integer part of x

Second Method:

The function tanh(x) is estimated in the following manner:

$$\begin{matrix}tanh ( x ) = 2 \times Sig ( 2 x ) - 1 \\ where & [ Math 8 ] \\ Sig ( x ) = \frac{1}{1 + exp ( - x )} & [ Math 9 ]\end{matrix}$$

Or more generally:

$$\begin{matrix}tanh ( β x ) = 2 \times Sig ( 2 β x ) - 1 \\ where & [ Math 10 ] \\ Sig ( λ x ) = \frac{1}{1 + exp ( - λ x )} & [ Math 11 ]\end{matrix}$$

Where λ=2β

Third Method:

To approximate the Gaussian:

$$f ( x ) = exp ( \frac{- {x}^{2}}{2 {σ}^{2}} ) \qquad [ Math 12 ]$$

The following method is used:

$$\begin{matrix}{sig}^{′} ( x ) = λ sig ( x ) ( 1 - sig ( x ) ) \\ Where & [ Math 13 ] \\ λ \approx \frac{1.7}{σ} & [ Math 14 ]\end{matrix}$$

Fourth Method:

It is unnecessary to go through an approximation to obtain a value of the RELU (“Rectified linear Unit”) function;

$$max ( 0 , x ) or \{ \begin{matrix}x & x ⩾ 0 \\ ax & x < 0\end{matrix} \} where λ = a$$

The four methods above constitute approximations of the original functions (sigmoid, hyperbolic tangent and Gaussian). However, the inventors have demonstrated (see appendix) that the approximations obtained using the technique of the invention provide results similar to those from an exact expression of the function.

FIG. 2 In view of the above, FIG. 2 shows the general architecture of the activation function circuit. This functional architecture takes into account the previous approximations (methods 1 to 4) and the factorisations in the computational functions.

The advantages of the present technique are as follows
a hardware implementation of a generic neural network with a configurable neural cell that allows the implementation of any neural network including convnet.
for certain embodiments, an original approximation of the fixed point or floating point calculation, of the sigmoid, of the hyperbolic tangent, of the Gaussian.
an implementation of the AFU in the form of a software library for standard processors or for FPGAs.
integration of the AFU as a hardware architecture for all standard processors or for FPGAs or ASICs.
depending on the implementation modes, a division between 3 and 5 of the complexity of the calculations compared to standard libraries.

### 5.2. Description of an Embodiment of a Configurable Neuron

In this embodiment, only the operational implementation of the AFU is discussed.

The AFU performs the computation regardless of whether the processed values are represented as fixed or floating point. The advantage and originality of this implementation lies in the pooling (factorisation) of the computational blocks (blocks no. 2 to 4) to obtain the different nonlinear functions, this computation is defined as “the basic operation” in the following, it corresponds to an approximation of the computation of the sigmoid of the absolute value of λx:

$$f ( x ) = \frac{1}{1 + {e}^{\vert λ x \vert}} . \qquad [ Math 15 ]$$

Thus “the basic operation” is no longer a standard mathematical operation like addition and multiplication that is found in all conventional processors, but the sigmoid function of the absolute value of λx. This “basic operation”, in this embodiment, is common to all other nonlinear functions. In this embodiment, an approximation of this function is used. Thus, an approximation of a high-level function is used here to perform the computations of high-level functions without using standard methods for computing these functions. The result for a positive value of x of the sigmoid is deduced from this basic operation using the symmetry of the sigmoid function. The hyperbolic tangent function is obtained using the standard correspondence relation that links it to the sigmoid function. The Gaussian function is obtained by passing through the derivative of the sigmoid which is an approximate curve of the Gaussian, the derivative of the sigmoid is obtained by a product between the sigmoid function and its symmetric. The RELU function which is a linear function for positive x does not use the basic operation of computing nonlinear functions. The leaky RELU function that uses a linear proportionality function for negative x also does not use the basic operation of computing nonlinear functions.

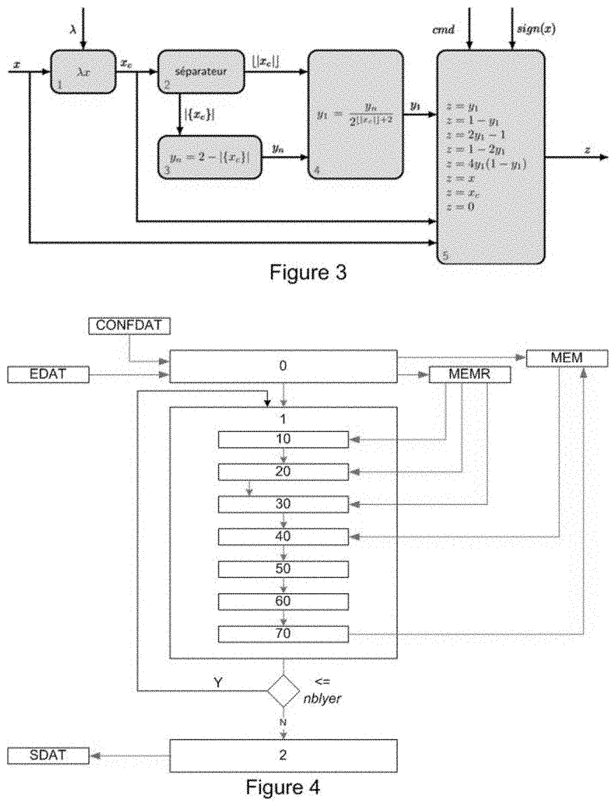

Finally, the function is chosen using a command word (cmd) as would a microprocessor instruction, the sign of the input value determines the computation method to be used for the chosen function. All the parameters of the different functions use the same parameter λ which is a positive real value regardless of the representation format. [FIG. 3] FIG. 3 illustrates this embodiment in more detail. Specifically in relation to this FIG. 3:
Block 1 multiplies the input data x by the parameter whose meaning depends on the activation function used: directly λ when using the sigmoid,

$$β = \frac{λ}{2}$$

when using the hyperbolic tangent function and

$$σ \approx \frac{1.7}{λ}$$

for the Gaussian, the proportionality coefficient “a” for a negative value of x when using the leakyRELU function; this calculation thus provides the value x_{c} for blocks no. 2 and no. 5. This block performs a multiplication operation whatever the format of representation of the real values. Any multiplication method that performs the calculation and provides the result, regardless of the format in which these values are represented, identifies this block. In the case of the Gaussian, the division can be included or not in the AFU.
Blocks no. 2 to 4 calculate the “basic operation” of nonlinear functions except for the RELU and leakyRELU functions which are linear functions with different proportionality coefficients depending on whether x is negative or positive. This basic operation uses a straight-line segment approximation of the sigmoid function for a negative value of the absolute value of x. These blocks can be grouped by two or three depending on the desired optimisation. Each straight-line segment is defined on an interval between the integer part of x and the integer part plus one of x:
block no. 2, named separator, extracts the integer part, takes the absolute value, this can also be translated by the absolute value of the default integer part of x:└|x|┘. It also provides the absolute value of the fractional part of x:|{x}|. The truncated part provided by this block gives the beginning of the segment and the fractional part represents the straight-line defined on this segment. The separation of the integer and fractional parts can be achieved in any way possible and regardless of the format in which x is represented.
block no. 3 computes the numerator yₙ of the final fraction from the fractional part|{x}| provided by block no. 2. This block provides the equation of the straight-line of the form 2−|{x}| independently of the segment determined with the truncated part.
block no. 4 computes the value common to all functions y₁ from the numerator yₙ provided by block no. 3 and the integer part provided by block no. 2. This block computes the common denominator for the elements of the line equation which provides a different straight-line for each segment with a minimum error between the real curve and the approximated value obtained with the straight-line. Using a power of 2 simplifies the calculation of the basic operation. This block therefore uses an addition and a subtraction which remains an addition in terms of algorithmic complexity followed by a division by a power of 2.
Block no. 5 computes the result of the nonlinear function which depends on the value of the command word cmd, the value of the sign of x and of course the result y₁ of block no. 4.
For a first cmd value, it provides the parameter sigmoid λ which is equal to the result of the basic operation for negative x (z=y₁ for x<0) and equal to 1 minus the result of the basic operation for positive x (z=1 y₁ for x≥0); this calculation uses the symmetry of the sigmoid function between positive and negative values of x. This calculation uses only subtraction. In this case we obtain a sigmoid with, in the worst case, an additional subtraction operation.
For a second value, it provides the hyperbolic tangent of parameter β which corresponds to twice the basic operation minus one with a negative value of x z=2y₁−1(x<0) and one minus two times the basic operation for a positive value of x (z=1−2y₁ for x≥0). The division of the value of x by two is integrated by the coefficient ½ in the parameter λ=2β or is done at this level where λ=β.
For a third value, it provides the Gaussian z=4y₁(1−y₁) regardless of the sign of x. Indeed the Gaussian is approximated using the derivative of the sigmoid. With this method we obtain a curve close to the Gaussian function. Moreover, the derivative of the sigmoid is calculated simply by multiplying the result of the basic operation by its symmetric. In this case, the parameter defines the standard deviation of the Gaussian by dividing 1.7 by λ. This division operation may or may not be included in the AFU. Finally, this calculation uses a multiplication with two operands and by a power of two.
For a fourth value, it provides the function RELU which gives the value of x for positive xz=x for x≥0 and 0 for negative xz=0 for x<0. In this case, the value of x is used directly without using the basic operation.
For a last value, a variant of the RELU function (leakyRELU) which gives the value of x for positive x z=x for x≥0 and a value proportional to x for negative xz=x_{c} for x<0. The proportionality coefficient is provided by the parameter λ.

Thus, block no. 5 is a block which contains the various final computations of the nonlinear functions described previously, as well as a switching block which carries out the choice of the operation according to the value of the control signal and the value of the sign of x.

### 5.3. Description of an Embodiment of a Dedicated Component Capable of Implementing a Plurality of Different Neural Networks, Method of Processing Data

In this illustrative embodiment, the component comprising a set of 16384 reconfigurable neurons is positioned on the processor. Each of these reconfigurable neurons receives its data directly from the temporary storage memory, which comprises at least 16384 entries (or at least 32768, depending on the embodiment), each input value corresponding to a byte. The size of the temporary storage memory is therefore 16 kb (or 32 kb) (kilobytes). Depending on the operational implementation, the size of the temporary storage memory can be increased to facilitate the rewriting processes of the result data. The component also includes a memory for storing the neural network configuration. In this example it is assumed that the configuration storage memory is sized to allow the implementation of 20 layers, each of these layers potentially comprising a number of synaptic weights corresponding to the total number of possible entries, that is, 16384 different synaptic weights for each of the layers, each of a size of one byte. For each layer, according to the invention, there are also at least two command words, each of a length of one byte, that is, a total of 16386 bytes per layer, and therefore for the 20 layers, a minimum total of 320 kB. This memory also includes a set of registers dedicated to the storage of data representative of the network configuration: number of layers, number of neurons per layer, ordering of the results of a layer, etc. In this configuration, the entire component requires a memory size of less than 1 MB.

### 5.4. Other Characteristics and Benefits

[FIG. 4] The operation of the reconfigurable neural network is presented in relation to FIG. 4. At initialisation (step 0), a set of data (EDAT), corresponding for example to a set of application data from a given hardware or software application is loaded into the temporary storage memory (MEM). A set of data, corresponding to the set of synaptic weights and layer configurations (CONFDAT) is loaded into the network configuration storage memory (MEMR).

The neural network is then executed (step 1) by the processor of the invention, according to an iterative implementation (as long as the current layer is less than the number of layers of the network, i.e. nblyer), of the following steps executed for a given layer of the neural network, from the first layer to the last layer, and comprising for a current layer:
transmission (10) of the first control word to the set of implemented neurons, defining the implemented combination function (linear combination or Euclidean norm) for the current layer;
transmission (20) of the second control word to the set of implemented neurons, defining the activation function implemented for the current layer;
loading (30) of the synaptic weights of the layer;
loading (40) the input data into the temporary storage memory;
computing (50) the combination function, for each neuron and each input vector, as a function of the control word, delivering, for each neuron used, an intermediate scalar;
computing (60) the activation function as a function of the intermediate scalar, and the second control word, delivering, for each neuron used, an activation result;
recording (70) the activation result in the temporary storage memory.

It is noted that the steps of transmitting the control words and calculating the results of the combination and activation functions are not necessarily physically separate steps. Furthermore, as explained above, one and the same control word can be used instead of two control words, in order to specify both the combination function and the activation function used.

The final results (SDAT) are then returned (step 2) to the calling application or component.

1. A data processing processor, said processor comprising:
at least one processing memory; and
a computation unit, which comprises a set of configurable computation units called configurable neurons, each configurable neuron of the set of configurable neurons comprising a module configured to compute combination functions and a module configured to compute activation functions, each module configured to compute activation functions comprising a register for receiving a configuration command, so that said command determines an activation function to be executed from at least two activation functions that can be executed by the module for computing activation functions.

2. The data processing processor according to claim 1, wherein the at least two activation functions executable by the module configured to compute activation functions belong to the group consisting of:
the sigmoid function;
the hyperbolic tangent function;
the Gaussian function;
the RELU (Rectified linear Unit) function.

3. The data processing processor according to claim 1, wherein the module configured to compute activation functions is configured to perform an approximation of said at least two activation functions.

4. The data processing processor according to claim 3, wherein the module configured to compute activation functions comprises a sub-module configured to compute a basic operation corresponding to an approximation of the calculation of the sigmoid of the absolute value of λx:
f(x)=1/1+^{|λx|}.

5. The data processing processor according to claim 3, wherein the approximation of said at least two activation functions is performed as a function of an approximation parameter λ.

6. The data processing processor according to claim 3, wherein the approximation of said at least two activation functions is performed by configuring the module configured to compute activation functions so that the computations are performed in fixed point or floating point modes.

7. The data processing processor according to claim 5, wherein the number of bits associated with fixed-point or floating-point calculations is set for each layer of a neural network configured on the basis of said set of configurable neurons.

8. The data processing processor according to claim 1, which comprises a network configuration storage memory within which neural network execution parameters are recorded.

9. A data processing method, said method being implemented by a data processing processor comprising at least one processing memory and a computation unit, the computation unit comprising a set of configurable computation units called configurable neurons, each configurable neuron of the set of configurable neurons comprising a module configured to compute combination functions and a module configured to compute activation functions, the method comprising:
an initialisation step comprising loading in the processing memory a set of application data and loading a set of data, corresponding to a set of synaptic weights and layer configurations of a neural network in a network configuration storage memory;
executing the neural network, according to an iterative implementation, comprising for each layer of the neural network, applying a configuration command, so that said command determines an activation function to be executed from at least two activation functions executable by a module configured to compute activation functions, the execution delivering processed data; and
transmitting the processed data to a calling application.

10. The data processing method according to claim 9, wherein the execution of the neural network comprises at least one iteration of the following steps, for a current layer of the neural network:
transmitting at least one control word, defining the combination function and/or the activation function implemented for the current layer;
loading synaptic weights of the layer;
loading input data into a temporary storage memory;
computing the combination function, for each neuron and each input vector, as a function of said at least one control word, delivering, for each neuron used, an intermediate scalar;
computing the activation function as a function of the intermediate scalar, and said at least one second control word, delivering, for each neuron used, an activation result; and
recording the activation result in the temporary storage memory.

11. A non-transitory computer-readable medium comprising program code instructions stored thereon for executing a method, when the instructions are executed on a data processing processor, the data processing processor comprising at least one processing memory and a computation unit, the computation unit comprising a set of configurable computation units called configurable neurons, each configurable neuron of the set of configurable neurons comprising a module configured to compute combination functions and a module configured to compute activation functions, wherein the instructions configure She data processing processor to:
perform an initialisation step comprising loading in a processing memory a set of application data and loading a set of data, corresponding to a set of synaptic weights and layer configurations in a network configuration storage memory;
executing the neural network, according to an iterative implementation, comprising for each layer of the neural network, applying a configuration command, so that said command determines an activation function to be executed front at least two activation functions executable by a module configured to compute activation functions, the execution delivering processed data; and
transmitting the processed data to a calling application.
